(19) United States
(12) Patent Application Publication
(10) Pub. No.: US 2026/0208177 A1
(43) Pub. Date: Jul. 23, 2026

(54) PFAS DEGRADATION SEMICONDUCTOR DEVICE

(71) Applicants: Boise State University, Boise, ID (US); PearlhillTechnologies,LLC, IdahoFalls, ID (US)

(72) Inventors: Kristy Voss, Boise, ID (US); Isaac Kreft, Boise, ID (US); Bamidele Omotowa, Boise, ID (US)

(73) Assignees: Boise State University, Boise, ID (US); Pearlhill Technologies, LLC, Idaho Falls, ID (US)

(21) Appl. No.: 19/456,940

(22) Filed: Jan. 22, 2026

Related U.S. Application Data
(60) Provisional application No. 63/748,374, filed on Jan. 22, 2025.

(51) Int. Cl. B01J 35/39; B01J 21/06; C02F 1/32

(52) U.S. Cl. CPC B01J 35/39; B01J 21/063; C02F 1/32; C02F 2305/10

(57) ABSTRACT

Systems and methods for perfluoroalkyl substances (PFAS) degradation that include a semiconductor device having a semiconductor layer having a fluid flow channel formed in a surface thereof and a photocatalytic active layer formed on a surface of the semiconductor layer and coating the fluid flow channel. A first electrode is formed on a first side of the fluid flow channel and a second electrode is formed on a second side of the fluid flow channel. Light from at least one light source is incident on the fluid flow channel and wherein, in response to the light incident at the photocatalytic active layer, electron-hole pairs are generated within the photocatalytic active layer and wherein interaction between the electron-hole pairs generated result in free electrons, wherein the free electrons weaken bonds within a perfluoroalkyl substance (PFAS) within the fluid flow channel, and wherein an electric field between the first electrode and the second electrode breaks the bonds, thereby degrading the PFAS.

### CROSS-REFERENCE TO RELATED APPLICATIONS

This application, under 35 U.S.C. § 119, claims the benefit of U.S. Provisional Patent Application Ser. No. 63/748,374 filed on Jan. 22, 2025, and entitled “PFAS DEGRADATION SEMICONDUCTOR DEVICE,” the contents of which are hereby incorporated by reference herein.

This application is also related to U.S. patent application Ser. No. 19/319,302 filed on Sep. 4, 2025, and entitled “Environmental Chemical Detection with the Optically Gated Transistor (ENVIROGT),” the contents of which are hereby incorporated by reference herein.

### FIELD OF THE DISCLOSURE

This disclosure is generally related to the field of perfluoroalkyl substances (PFAS) degradation and, in particular, to a method and/or device for PFAS degradation and separation using an electric field induced field flow fractionation with photocatalysis.

### BACKGROUND

The present technology for degradation of PFAS typically consists of three methods: (1) chemical degradation—through a chemical reaction; (2) photocatalytic degradation (a promising technology for PFAS treatment)—light on a molecule that interacts with the PFAS and eventually (e.g., from many minutes to days) causes separation of PFAS molecules; and (3) ultrasonic degradation—in liquid solution, the ultrasonic waves heat the water and the resultant heat causes the PFAS molecules to degrade.

The present inventors have developed the disclosed devices that can be used to decompose and separate PFAS. Generally, PFAS are damaging toxins detectable in the blood of humans and animals worldwide and, in particular, in 98% of Americans. In 2019, the Environmental Protection Agency (EPA) testified to the Senate Committee on Environment and Public Works that there were 180 Superfund Sites in 47 states with PFAS contamination. The Centers for Disease Control and Prevention (CDC) has associated environmental exposure to PFAS with numerous chronic and life-threatening diseases, most notably for particular hazardous occupational settings and too often among underserved communities. Researchers, epidemiologists, governments, and environmental monitoring companies must monitor personal exposure to complete population studies. However, detecting PFAS at nanomolar concentrations in aqueous environments is limited, slow, and costly because conventional detection typically requires chromatography coupled with electrospray-ionization mass spectrometry in professional laboratories. Developing sensors to detect contaminants is a growing challenge in environmental monitoring and management. The EPA has categorized PFAS as emerging environmental pollutants and has set limits of 4-10 ppt for five specific PFAS compounds in drinking water. There is currently no device for field detection of an analyte from among hundreds of PFAS contaminants in complex mixtures in water. The EPA, National Institute for Environmental Health Science (NIEHS), and other federal agencies have stated an unmet need for (1) inexpensive, selective and sensitive, field sensors for simultaneous sensing of contaminants; and (2) tools to detect these contaminants in the air at micro- to nanomolar concentrations. Other unmet needs, drawbacks of existing systems, and issues with current technology also exist.

### SUMMARY

Accordingly, disclosed embodiments address the above, and other, unmet needs, drawbacks of existing systems, and issues with current technology. Disclosed embodiments include a semiconductor device capable of degrading or breaking down PFAS compounds. Disclosed devices use a combination of electrochemical and photocatalytic mechanisms for chemical breakdown. In some disclosed embodiments, the photocatalytic process is sped up by at least three orders of magnitude and made more efficient.

Disclosed embodiments include, a semiconductor device having a doped silicon layer having a canal formed in a surface thereof, a photocatalytic active layer formed on a surface of the doped silicon layer and coating the canal, a first electrode formed on a first side of the canal, a second electrode formed on a second side of the canal, and wherein, in response to light from at least one light source incident at the photocatalytic active layer, electron-hole pairs are generated within the photocatalytic active layer and within the doped silicon layer, wherein interaction between the electron-hole pairs generated within the photocatalytic active layer and within the doped silicon layer result in free electrons, wherein the free electrons weaken bonds within a PFAS within the canal, and wherein an electric field between the first electrode and the second electrode breaks the bonds, thereby degrading the PFAS.

In some embodiments the photocatalytic active layer comprises titanium dioxide (TiO2). In some embodiments the photocatalytic active layer comprises a chalcogenide-based material, ZnO, ITO, n-doped WO3, or any combination thereof.

In some embodiments the first electrode has a varying width along the canal. In some embodiments the second electrode has a varying width along the canal. In some embodiments both the first electrode and the second electrode have varying widths along the canal.

Also disclosed is a system for PFAS degradation including a semiconductor device having a semiconductor layer having a fluid flow channel formed in a surface thereof, a photocatalytic active layer formed on a surface of the semiconductor layer and coating the fluid flow channel, a first electrode formed on a first side of the fluid flow channel, and a second electrode formed on a second side of the fluid flow channel, and at least one light source, and wherein, in response to light from at least one light source incident at the photocatalytic active layer, electron-hole pairs are generated within the photocatalytic active layer and wherein interaction between the electron-hole pairs generated result in free electrons, wherein the free electrons weaken bonds within a PFAS within the fluid flow channel, and wherein an electric field between the first electrode and the second electrode breaks the bonds, thereby degrading the PFAS.

In some embodiments the system further includes a second light source in addition to the at least one light source. In some embodiments the wavelength of light from the second light source is different than the wavelength of light from the at least one light source. In some embodiments the light from the second light source is incident on the semiconductor layer.

In some embodiments the electric field between the first electrode and the second electrode varies along the fluid flow channel.

In some embodiments the at least one light source is configured to generate visible light in a first wavelength associated with generation of the electron-hole pairs in the photocatalytic active layer and ultraviolet light in a second wavelength associated with generation of the electron-hole pairs in the semiconductor layer.

Also disclosed is a method for PFAS degradation including providing a semiconductor device having a semiconductor layer having a fluid flow channel formed in a surface thereof, a photocatalytic active layer formed on a surface of the semiconductor layer and coating the fluid flow channel, a first electrode formed on a first side of the fluid flow channel, and a second electrode formed on a second side of the fluid flow channel, and generating an electric field between the first electrode and the second electrode, introducing a PFAS substance or suspected PFAS substance into the fluid flow channel, and directing a first light source at the photocatalytic active layer.

In some embodiments the method includes directing a second light source at the semiconductor layer. In some embodiments the first light source comprises light that generates electron-hole pairs in the photocatalytic active layer and the second light source comprises light that generates electron-hole pairs in the semiconductor layer.

Other embodiments also exist.

### BRIEF DESCRIPTION OF THE DRAWINGS

FIG. 1A is an exemplary illustration of a canal etch mask in accordance with disclosed embodiments and FIG. 1B is an exemplary illustration of an electrode shadow mask in accordance with disclosed embodiments.

FIG. 2 is a schematic illustration showing a layer of photocatalytic material and a canal coated in photocatalytic material in accordance with disclosed embodiments.

FIG. 3 is a schematic illustration of a method of manufacturing a CENVIR-OGT in accordance with disclosed embodiments.

FIG. 4 is a schematic illustration of a method of use for a CENVIR-OGT in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

As disclosed in co-pending application, U.S. patent application Ser. No. 19/319,302 filed on Sep. 4, 2025, entitled “Environmental Chemical Detection with the Optically Gated Transistor (ENVIR-OGT),” optically-gated transistor (OGT) and environmental OGT (ENVIR-OGT) can interact with PFAS. As disclosed herein, by replacing the active layer of, for example, an ENVIR-OGT with photocatalytic materials, such as TiO₂, Ge₂Se₃, ZnO, ITO, and N-doped WO₃, along with others, electron hole pairs are generated in the active materials while illuminated, as well as in the underlying doped Si substrate, which subsequently result in activation of a contacting material such as a liquid containing PFAS. As used herein, “electron holes” (or “e-h”) may include defects or photogenerated electrons or photogenerated holes in the active layer and electron-hole pairs, as they are traditionally understood, in the underlying Si layer. The interaction of the electrons in the underlying doped Si layer with the generated holes in the photocatalytic material results in an abundance of free electrons, and vice versa—generation of free holes. These electrons and holes readily attack the PFAS materials at electron deficient bonds, resulting in bond weakening. An applied electric field between the source and drain electrodes results in full separation of the materials, thus speeding up the relatively slow photocatalytic process, making it feasible for PFAS degradation.

As also disclosed herein, embodiments may include a structure with a sample flowing/holding canal and using multiple LED wavelengths to assist in the PFAS degradation. The canal concept and multiple wavelength exposure device uses a combination of electrochemical and photocatalytic mechanisms for chemical separation and breakdown. Additionally, disclosed embodiments may employ shaped electrodes to focus the electric field along the canal. This process resembles a combination of an electric field influenced flow fractionation (EFIFFF) technique and a photocatalytic degradation technique.

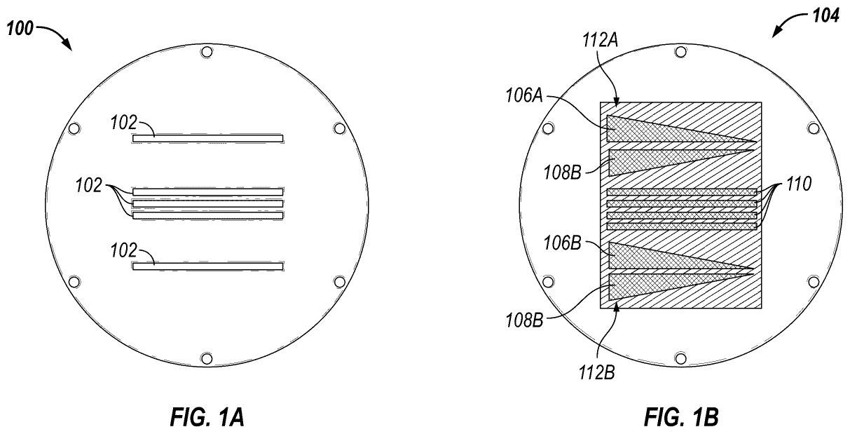

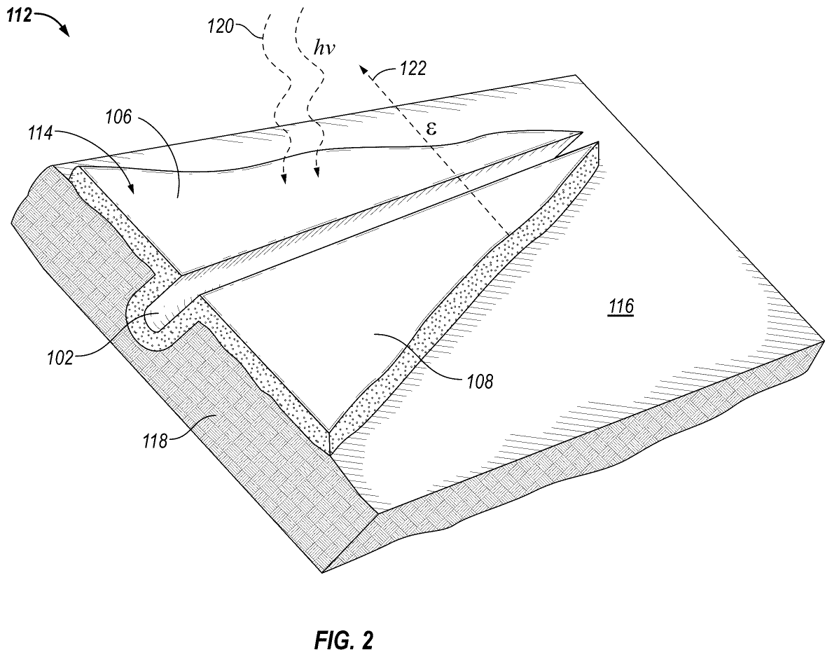

Disclosed embodiments include, with reference to FIGS. 1 and 2, Canal Environmental Optically Gated Transistor (CENVIR-OGT) embodiments. In these embodiments, the photocatalytic electrochemical degradation yield is improved by allowing both static and dynamic PFAS-containing solutions to be treated, by creating a spatially variable area electrode pad structure for the source and drain and a valley (i.e., a canal) between the source and drain electrodes. One embodiment of a layout of this basic structure is shown with reference to FIGS. 1A-1B, which show top-down views of the etch masks 100, 104 used to create the canals 102 (FIG. 1A) and electrodes 106, 108 (FIG. 1B). The canals 102 may be etched through etch mask 100. The electrodes 106A, 106B, 108A, 108B in FIG. 1B indicate open regions in the mask for electrode material deposition as would be understood by those of ordinary skill in the art having the benefit of this disclosure. As would also be understood, the two mask layouts 100, 104 overlay to form the devices. In FIG. 1B the adjacent triangular electrodes grouped at the top (i.e., 106A, 108A) and bottom (i.e., 106B, 108B) represent two different CENVIR-OGTs 112. In some embodiments, a middle set of four electrodes 110 represent close coupled canals for triplicate simultaneous degradation tests or the like.

As better illustrated with reference to FIG. 2, in some embodiments, a solution sample containing PFAS may be injected at one end of the canal 102 and forced toward the opposite end (e.g., by a gas, liquid, physical plunger, or the like). An electric field 122 can cause separation of PFAS components, with and without light 120, in a way that has some similarity to EFIFFF techniques. However, in the CENVIR-OGT 112, due to the shape of electrodes 106, 108 the electric field 122 varies along the length of the canal 102, thus further assisting PFAS separation. While source electrode 106 and drain electrode 108 are shown as generally tapering triangles, other shapes may also be used to vary the electric field 122 along the length of the canal 102. Furthermore, the underlying e-h pairs assist in the capture and degradation of the PFAS due to the attraction and repulsion between the majority free carrier in the underlying photoactive doped semiconductor 118 (see, e.g., FIG. 2, which shows the case of p-Si as the underlying doped semiconductor 118) and the photocatalyst 116. As also indicated electrodes 106, 108 may be covered with photocatalyst layer 114 that may be the same as or different from photocatalyst 116..

As a further example, a p-Si layer (e.g., doped layer 118) generates e-h pairs upon illumination (e.g., light 120). Under illumination 120, the concentration of electrons in the conduction band of p-Si increases. Simultaneously, the photocatalyst (e.g., 116) will generate e-h pairs. The p-Si conduction band electrons in layer 118 will attract the excess holes in the photocatalyst 116, thus providing a higher concentration of electrons in the photocatalyst 116. These electrons are readily available for interaction with the incoming PFAS molecules.

The underlying doped Si layer 118 of the CENVIR-OGT 112 uses a light 120 in the wavelength range that stimulates electron-hole (e-h) pair generation in Si (e.g., visible wavelengths ~380 nm to 750 nm). Illumination UV light wavelengths (e.g., ~100 nm to 400 nm) may also be used to generate e-h pairs with specialty designed Si films. Other semiconductor material with different wavelength requirements for electron-hole pair generation may also be used. For example, InSb or Ge may be used. Further, a semiconductor that requires UV light may be used if one wanted to more closely match wavelengths with the photocatalysts that use UV light. An example of a semiconductor that can absorb light in the UV is AlGaN.

Most photocatalytic degradation processes using metal oxide photocatalysts require UV light in order to catalyze the degradation of materials. In some disclosed embodiments it may be preferable to include the use of at least two wavelengths of light 120 for the PFAS degradation process. One of these may be a UV source to enable photocatalytic reduction and the other may be used to stimulate the e-h generation in Si to assist in the trap and capture process. In some cases, one or more UV sources may enable multiple species degradation. As would be understood by those of ordinary skill in the art having the benefit of this disclosure various kinds of light sources 120 may be used including, but not limited to, single or nearly single wavelength sources, multiple wavelength sources, multiple points of incidence, multiple angles of incidence, various intensities, and the like. Furthermore, as disclosed herein, Si may be important in embodiments when the Si is being used to assist in the degradation, but TiO₂ or other photocatalytic layer 114 may also be capable on its own of photodegradation (see, e.g., TiO₂ assisted degradation of organic pollutants and heavy metal compounds like HgCl₂). As disclosed here the underlying Si and its photoresponse assist in forcing or speeding up the TiO₂ degradation process.

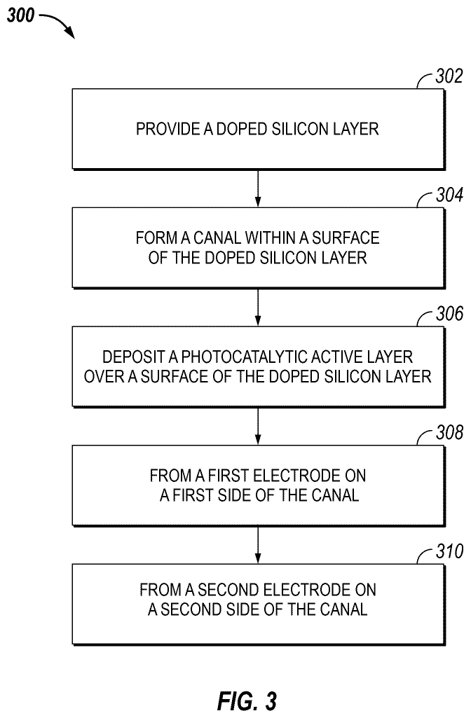

FIG. 3 is a schematic illustration of a method of manufacturing 300 a CENVIR-OGT in accordance with disclosed embodiments. As illustrated schematically, and disclosed herein, at 302 a CENVIR-OGT may be manufactured by providing a doped silicon or other semiconductor layer. At 304 a canal or other fluid flow structure (e.g., canal 102) may be provided on a surface of doped silicon layer. At 306 a photocatalytic layer (e.g., layer 114 of TiO₂ or the like) may be deposited on the surface of the doped silicon layer. At 308 and 310 electrodes (e.g., source 106 and drain 108) may be formed on opposite sides of the canal or other fluid flow structure. As would be understood by those of ordinary skill in the art having the benefit of this disclosure, the above is an exemplary description of the manufacturing processes that may be used and different ordering of steps, different materials, and different shapes and configurations may also be used.

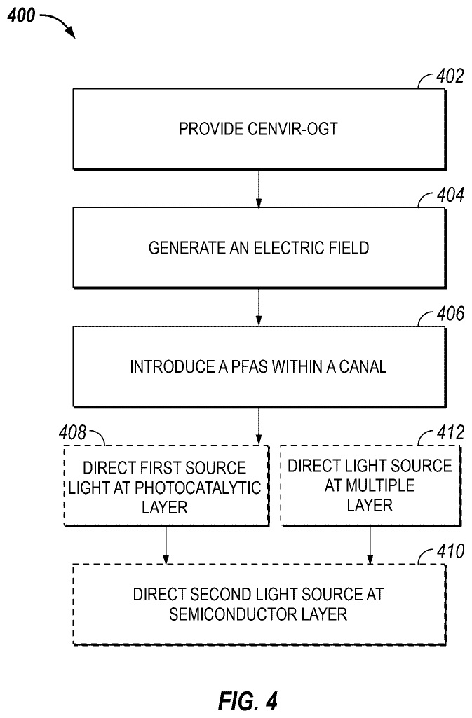

FIG. 4 is a schematic illustration of a method of use 400 for a CENVIR-OGT in accordance with disclosed embodiments. As illustrated schematically, and disclosed herein, at 402 a CENVIR-OGT (e.g., CENVIR-OGT 112) may be provided and appropriately connected. At 404 an electric field is generated (e.g., electric field 122) using one or more of the electrodes (e.g., 106, 108) of the CENVIR-OGT. At 406 a PFAS or suspected PFAS containing substance may be introduced into the canal (e.g., canal 102) or other fluid flow structure on the CENVIR-OGT. As indicated at 408 a first light source (e.g., light source 120) having a first wavelength of light may illuminate a photocatalytic layer (e.g., layer 114). As indicated at 410, some embodiments may also direct a second light source having a second wavelength of light at the semiconductor layer (e.g., layer 118). As indicated at 412, some embodiments may direct a light source having multiple wavelengths of light at multiple layers of the CENVIR-OGT as disclosed herein. As would be understood by those of ordinary skill in the art having the benefit of this disclosure, the above is an exemplary description of the use processes that may be implemented and different ordering of steps or combinations thereof may also be used.

Although various embodiments have been shown and described, the present disclosure is not so limited and will be understood to include all such modifications and variations as would be apparent to one skilled in the art.

What is claimed is:

1. A semiconductor device comprising:
a doped silicon layer having a canal formed in a surface thereof;
a photocatalytic active layer formed on a surface of the doped silicon layer and coating the canal;
a first electrode formed on a first side of the canal;
a second electrode formed on a second side of the canal; and
wherein, in response to light from at least one light source incident at the photocatalytic active layer, electron-hole pairs are generated within the photocatalytic active layer and within the doped silicon layer, wherein interaction between the electron-hole pairs generated within the photocatalytic active layer and within the doped silicon layer result in free electrons, wherein the free electrons weaken bonds within a perfluoroalkyl substance (PFAS) within the canal, and wherein an electric field between the first electrode and the second electrode breaks the bonds, thereby degrading the PFAS.

2. The semiconductor device of claim 1, wherein the photocatalytic active layer comprises titanium dioxide (TiO₂).

3. The semiconductor device of claim 1, wherein the photocatalytic active layer comprises a chalcogenide-based material, ZnO, ITO, n-doped WO₃, or any combination thereof.

4. The semiconductor device of claim 1, wherein the first electrode has a varying width along the canal.

5. The semiconductor device of claim 1, wherein the second electrode has a varying width along the canal.

6. The semiconductor device of claim 1, wherein the first electrode and the second electrode have varying widths along the canal.

7. A system for perfluoroalkyl substances (PFAS) degradation comprising:
a semiconductor device comprising:
a semiconductor layer having a fluid flow channel formed in a surface thereof;
a photocatalytic active layer formed on a surface of the semiconductor layer and coating the fluid flow channel;
a first electrode formed on a first side of the fluid flow channel; and
a second electrode formed on a second side of the fluid flow channel; and
at least one light source; and
wherein, in response to light from at least one light source incident at the photocatalytic active layer, electron-hole pairs are generated within the photocatalytic active layer and wherein interaction between the electron-hole pairs generated result in free electrons, wherein the free electrons weaken bonds within a perfluoroalkyl substance (PFAS) within the fluid flow channel, and wherein an electric field between the first electrode and the second electrode breaks the bonds, thereby degrading the PFAS.

8. The system of claim 7, wherein the photocatalytic active layer comprises titanium dioxide (TiO₂₎.

9. The system of claim 7, wherein the photocatalytic active layer comprises a chalcogenide-based material, ZnO, ITO, n-doped WO₃, or any combination thereof.

10. The system of claim 7 further comprising:
a second light source in addition to the at least one light source.

11. The system of claim 10, wherein the wavelength of light from the second light source is different than the wavelength of light from the at least one light source.

12. The system of claim 11, wherein the light from the second light source is incident on the semiconductor layer.

13. The system of claim 7, wherein the electric field between the first electrode and the second electrode varies along the fluid flow channel.

14. The system of claim 7, wherein the first electrode and the second electrode have varying widths along the fluid flow channel.

15. The system of claim 7, wherein the at least one light source is configured to generate visible light in a first wavelength associated with generation of the electron-hole pairs in the photocatalytic active layer and ultraviolet light in a second wavelength associated with generation of the electron-hole pairs in the semiconductor layer.

16. A method for perfluoroalkyl substances (PFAS) degradation comprising:
providing a semiconductor device comprising:
a semiconductor layer having a fluid flow channel formed in a surface thereof;
a photocatalytic active layer formed on a surface of the semiconductor layer and coating the fluid flow channel;
a first electrode formed on a first side of the fluid flow channel; and
a second electrode formed on a second side of the fluid flow channel; and
generating an electric field between the first electrode and the second electrode;
introducing a PFAS substance or suspected PFAS substance into the fluid flow channel; and
directing a first light source at the photocatalytic active layer.

17. The method of claim 16, further comprising:
directing a second light source at the semiconductor layer.

18. The method of claim 17, wherein the first light source comprises light that generates electron-hole pairs in the photocatalytic active layer and the second light source comprises light that generates electron-hole pairs in the semiconductor layer.

19. The method of claim 16, further comprising:
varying the electric field along the fluid flow channel.

20. The method of claim 19 wherein the electric field is varied by providing a first electrode of a varying width along the fluid flow channel.
